(19) United States
(12) Patent Application Publication
(10) Pub. No.: US 2026/0239444 A1
(43) Pub. Date: Aug. 13, 2026

(54) TERMINAL, COMMUNICATION METHOD AND WIRELESS COMMUNICATION SYSTEM

(71) Applicant: NTT DOCOMO, INC., Tokyo (JP)

(72) Inventors: Mayuko Okano, Chiyoda-ku, Tokyo (JP); Shinya Kumagai, Chiyoda-ku, Tokyo (JP); Hiroki Harada, Chiyoda-ku, Tokyo (JP)

(73) Assignee: NTT DOCOMO, INC., Tokyo (JP)

(21) Appl. No.: 19/471,197

(22) PCT Filed: Apr. 6, 2023
(86) PCT No.: PCT/JP2023/014275

§ 371 Date: Sep. 30, 2025

(51) Int. Cl. H04W 74/0833; H04W 76/20

(52) U.S. Cl. CPC H04W 74/0833; H04W 76/20

(57) ABSTRACT

A terminal includes: a transmission unit configured to perform an uplink transmission in an RRC (Radio Resource Control) inactive state; a control unit configured to expect to receive system information, at least one of: during execution of a data transmission procedure for performing the uplink transmission; before execution of the data transmission procedure; or after execution of the data transmission procedure; and a reception unit configured to receive the system information based on the expectation.

### TECHNICAL FIELD

The present invention relates to a terminal, a communication method, and a wireless communication system.

### BACKGROUND ART

Regarding NR (New Radio) (also referred to as “5G”) that is a successor system to LTE (Long Term Evolution), technologies have been discussed which satisfy the following requirements: a high capacity system, high data transmission rate, low delay, simultaneous connection of multiple terminals, low cost, power saving, etc. (for example, Non-Patent Literature 1).

In LTE or NR, there is a definition of a UE category or UE capability for IoT (Internet of Things) in which functions, such as functions related to transmission/reception bandwidth and the number of antennas, that are supported by a normal terminal as mandatory functions are reduced. For example, eMTC (enhanced Machine Type Communication) and NB-IoT (Narrow Band IoT) are defined in LTE, and RedCap (Reduced Capability), etc., are defined in NR.

In NR Release 17, RedCap UE (User Equipment) is specified to support separate initial BWP (Bandwidth part). Furthermore, in the NR standards, there is an agreement of using NCD-SSB (Non-Cell Defining Synchronization Signal Block) for SDT (Small Data Transmission) in the separate initial BWP configured for the RedCap UE. Here, the SDT is a function in which the UE performs uplink communications in the RRC_INACTIVE state.

It is to be noted that, in the conventional NR standards, transmission of NCD-SSB is specified to be performed in a limited case in which the RedCap UE is in the RRC_CONNECTED state.

### CITATION LIST

### Non-Patent Literature

Non-Patent Literature 1: 3GPP TS 38.300 V17.4.0

### SUMMARY OF INVENTION

### Technical Problem

Conventionally, transmission of NCD-SSB is not expected to be performed when the UE is in the RRC_INACTIVE state. Therefore, in the SDT procedure by the RedCap UE that is in the RRC_INACTIVE state, how NCD-SSB is to be received by the RedCap UE is unclear, and there is a risk that the RedCap UE cannot receive NCD-SSB appropriately.

The present invention has been made in view of the above points, and it is an object of the present invention to let the capability reduced terminal expect signal reception appropriately.

### Solution to Problem

A terminal according to an embodiment of the present invention includes: a transmission unit configured to perform an uplink transmission in an RRC inactive state; a control unit configured to assume to receive system information, at least one of: during execution of a data transmission procedure for performing the uplink transmission; before execution of the data transmission procedure; or after execution of the data transmission procedure; and a reception unit configured to receive the system information based on the assumption.

### Advantageous Effects of Invention

According to an embodiment of the present invention, a capability reduced terminal can receive a signal appropriately in the wireless communication system.

### BRIEF DESCRIPTION OF DRAWINGS

FIG. 1 is a drawing for describing a wireless communication system in an embodiment of the present invention.

FIG. 2 is a drawing illustrating an example of BWP configuration for the RedCap UE for NR Release 17.

FIG. 3 is a drawing illustrating an example of an operation for receiving NCD-SSB in the RA-SDT procedure with 4-step RACH in the first embodiment.

FIG. 4 is a drawing illustrating an example of an operation for receiving NCD-SSB in the RA-SDT procedure with 2-step RACH in the first embodiment.

FIG. 5 is a drawing illustrating an example of an operation for receiving NCD-SSB in the RA-SDT procedure with 4-step RACH in the first embodiment.

FIG. 6 is a drawing illustrating an example of an operation for receiving NCD-SSB in the SDT procedure in the second embodiment,

FIG. 7 is a drawing illustrating an example of an operation for receiving NCD-SSB in the CG-SDT procedure in the third embodiment.

FIG. 8 is a drawing illustrating an example of a functional structure of a base station related to an embodiment of the present invention.

FIG. 9 is a drawing illustrating an example of a functional structure of a terminal related to an embodiment of the present invention.

FIG. 10 is a drawing illustrating an example of a hardware structure of the base station or the terminal related to an embodiment of the present invention.

FIG. 11 is a drawing illustrating an example of a structure of a vehicle related to an embodiment of the present invention.

### DESCRIPTION OF EMBODIMENTS

In the following, while referring to the drawings, one or more embodiments of the present invention will be described. It is to be noted that the embodiments described below are examples. Embodiments of the present invention are not limited to the following embodiments.

In operations of a wireless communication system according to an embodiment of the present invention, a conventional technique will be used when it is appropriate. It is to be noted that, although the conventional techniques may be the conventional LTE, the conventional techniques are not limited to the conventional LTE. Further, it is assumed that the term “LTE” used in the present specification has, unless otherwise specifically mentioned, a broad meaning including a scheme of LTE-Advanced and a scheme after LTE-Advanced (e.g.: NR).

Furthermore, in one or more embodiments described below, terms that are used in the existing LTE are used, such as SS (Synchronization signal), PSS (Primary SS), SSS (Secondary SS), PBCH (Physical broadcast channel), PRACH (Physical random access channel), PDCCH (Physical Downlink Control Channel), PDSCH (Physical Downlink Shared Channel), PUCCH (Physical Uplink Control Channel), PUSCH (Physical Uplink Shared Channel), etc. The above-described terms are used for the sake of description convenience. Signals, functions, etc., which are similar to the above-described terms, may be referred to as different names. In addition, the above-described terms in NR correspond to NR-SS, NR-PSS, NR-SSS, NR-PBCH, NR-PRACH, etc. However, even when a signal is used for NR, the signal is not required to be referred to as “NR-”.

In addition, in an embodiment of the present invention, the duplex method may be a TDD (Time Division Duplex) method, an FDD (Frequency Division Duplex) method, or any other method (e.g., Flexible Duplex, or the like).

Further, in an embodiment of the present invention, the expression that a radio parameter, or the like is “configured” may mean that a predetermined value is pre-configured, or may mean that a radio parameter indicated by a base station 10 or a terminal 20 is configured.

### System Configuration

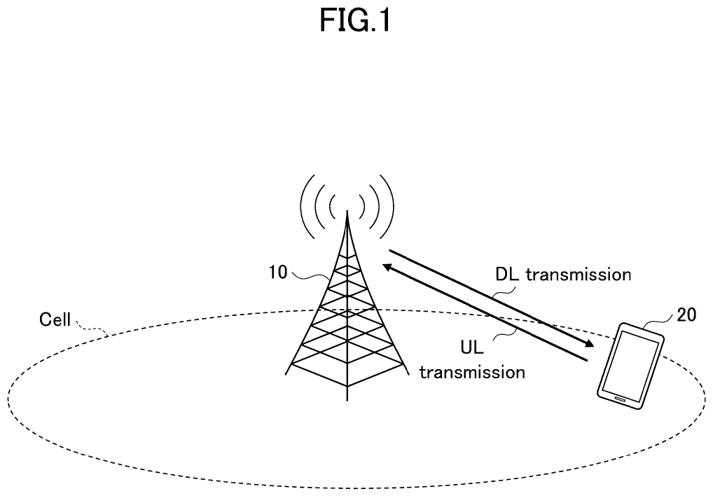

FIG. 1 is a drawing for describing a wireless communication system related to an embodiment of the present invention. As illustrated in FIG. 1, the wireless communication system according to an embodiment of the present invention includes a base station 10 and a terminal 20. In FIG. 1, a single base station 10 and a single terminal 20 are illustrated as an example, but there may be a plurality of base stations 10 and a plurality of terminals 20.

The base station 10 is a communication device that provides one cells and performs wireless communication with the terminal 20. Physical resources of radio signals may be defined in the time domain and the frequency domain, the time domain may be defined by the number of OFDM (Orthogonal Frequency Division Multiplexing) symbols, and the frequency domain may be defined by the number of sub-carriers or the number of resource blocks. Further, a TTI (Transmission Time Interval) in the time domain may be a slot, or the TTI may be a subframe.

The base station 10 transmits a synchronization signal and system information to the terminal 20. The synchronization signal is, for example, an NR-PSS and/or an NR-SSS. The system information may be transmitted via an NR-PBCH, and may be also referred to as broadcast information. The synchronization signal and the system information may be referred to as an SSB (SS/PBCH block). As illustrated in FIG. 1, the base station 10 transmits a control signal or data in DL (Downlink) to the terminal 20 and receives a control signal or data in UL (Uplink) from the terminal 20. The base station 10 and terminal 20 are capable of transmitting and receiving a signal by performing the beamforming. Further, the base station 10 and the terminal 20 can be both capable of applying MIMO (Multiple Input Multiple Output) communication to DL or UL. Further, the base station 10 and the terminal 20 may both perform communications via a secondary cell (SCell: Secondary Cell) and a primary cell (PCell: Primary Cell) using CA (Carrier Aggregation). In addition, the terminal 20 may perform communications via a primary cell of the base station 10 and a primary secondary cell group cell (PSCell: Primary SOG Cell) of another base station 10 using DC (Dual Connectivity).

The terminal 20 may be a communication apparatus that includes a wireless communication function such as a smartphone, a mobile phone, a tablet, a wearable terminal, a communication module for M2M (Machine-to-Machine), or the like. As illustrated in FIG. 1, the terminal 20 uses various communication services provided by the wireless communication system by receiving control signals or data in DL from the base station 10 and transmitting control signals or data in UL to the base station 10. In addition, the terminal 20 receives various reference signals transmitted from the base station 10 and performs measurement of the propagation path quality based on the reception result of the reference signals. It is to be noted that the terminal 20 may be referred to as a UE, and the base station 10 may be referred to as a qNB.

In addition, in NR, as a continued discussion from LTE, a carrier aggregation function using a wide band in order to allocate data resources is being discussed. In the carrier aggregation function, wide band data resources can be allocated by bundling a plurality of component carriers,

First, the conventional RedCap of NR Release 17 will be described. The maximum bandwidth supported by a RedCap UE is 20 MHz in FR1 (Frequency Range 1) and 100 MHz in FR2 (Frequency Range 2). In addition, the RedCap UE is required to coexist with a non-RedCap UE (hereinafter, also referred to as “Non-RedCap UE”) in the system.

In addition, a RedCap UE and a Non-RedCap UE may be enabled to share the same initial DL-BWP (Downlink Bandwidth part) (including the subcarrier spacing, bandwidth, and position) configured by MIB (Master Information Block). On the other hand, an initial DL-BWP having a separate or added subcarrier spacing, bandwidth, and position for the RedCap UE may be configured.

The RedCap UE can share the initial DL-BWP for Non-RedCap UE in a case where the maximum bandwidth supported by the RedCap UE is not exceeded.

In addition, according to the NR Release 17 technical specification, in a case of TDD, a DL-BWP and a UL-BWP with the same index must have the same center frequency in order to avoid the RF retuning.

In addition, a RedCap UE expects that an initial DL-BWP and an active DL-BWP are to be equal to or less than the maximum DL bandwidth supported by the RedCap UE after the (re)establishment of the dedicated RRC connection. A RedCap UE is provided with a DL-BWP by “initialDownlinkBWP” in “DownlinkConfigCommonRedCapSIB”, and is provided with a UL-BWP by “initialUplinkBWP” in “UplinkConfigCommonRedCapSIB”. In a case where “initialUplinkBWP” in “UplinkConfigCommonSIB” indicates a UL-BWP that is larger than the maximum UL-BWP supported by the RedCap UE, the RedCap UE expects that a UL-BWP is to be provided by “initialUplinkBWP” in “UplinkConfigCommonRedCapSIB”.

The RedCap UE may be provided with a DL-BWP by “BWP-DownlinkDedicated” other than the initial DL-BWP. The RedCap UE may be provided with a UL-BWP that is equal to or less than the maximum UL bandwidth supported by the RedCap UE by “BWP-UplinkDedicated” other than the initial UL-BWP.

In a case where the RedCap UE is provided with “RACH-ConfigCommonRedCap” or “RACH-ConfigCommonTwoStepRA-RedCap”, the RedCap UE performs an initial access and random access procedure by using the corresponding parameters. Otherwise, the RedCap UE uses the corresponding parameters provided by “RACH-ConfigCommon” or “RACH-ConfigCommonTwoStepRA”.

In a case where the RedCap UE is provided with “initialUplinkBWP” by “UplinkConfigCommonRedCapSIB” and there is no dedicated PUCCH resource configuration, the RedCap UE transmits PUCCH with HARQ-ACK information by using the PUCCH resource set provided by “PUCCH-ResourceCommonRedCap”. It is to be noted that the PUCCH transmission is disabled in a case where “disable-FH-PUCCH” is provided by “PUCCH-ConfigCommonRedCap”.

With respect to the initial DL-BWP provided by “initialDownlinkBWP” in “DownlinkConfigCommonRedCapSIB”, in a case where the RedCap UE monitors PDCCH according to the Type1-PDCCH CSS without monitoring PDCCH according to the Type2-PDCCH CSS set, the RedCap UE determines that the initial DL-BWP does not include SS/PBCH blocks or the CORESET with index 0.

In a case of monitoring PDCCH according to the Type2-PDCCH CSS set, the RedCap UE assumes that the initial DL-BWP includes SS/PBCH blocks and the CORESET with an index 0 if the RedCap UE has obtained SIB1 by using an SS/PBCH block and assumes that the initial DL-BWP does not include the CORESET with an index 0 if the initial DL-BWP includes SS/PBCH blocks but does not include the SS/PBCH block that the RedCap UE has used to obtain SIB1.

In a case of an active DL-BWP provided by “BWP-DownlinkDedicated”, unless the RedCap UE indicates a capability of operating in the DL-BWP without receiving an SS/PBCH block, the RedCap UE assumes that the active DL-BWP includes SS/PBCH blocks and does not include the CORESET with an index 0.

Next, the BWP configuration for the RedCap UE for NR Release 17 will be described.

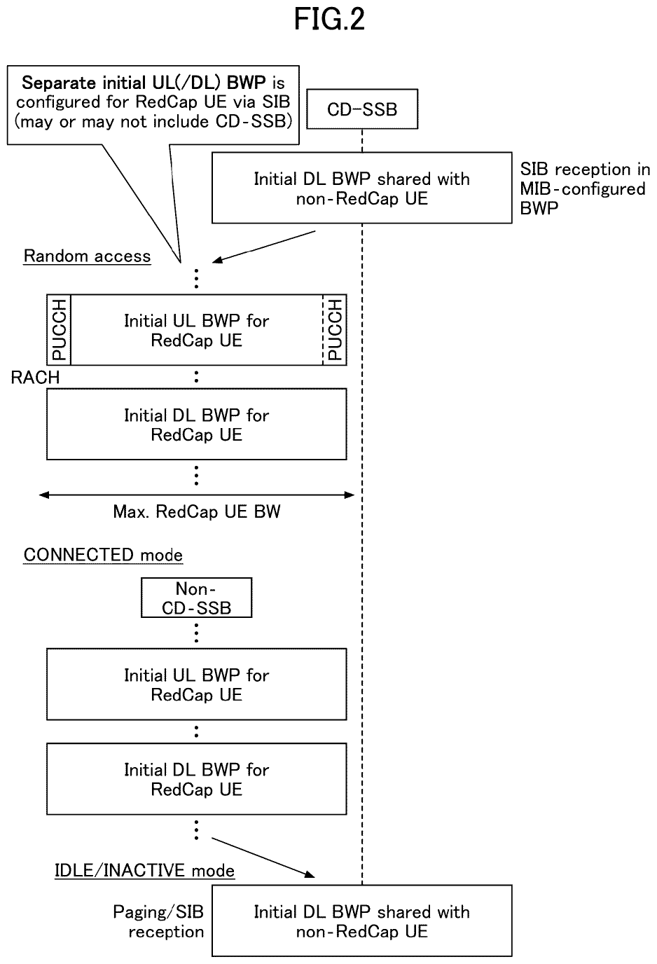

FIG. 2 is a drawing illustrating an example of the BWP configuration for the RedCap UE for NR Release 17. In a case where the DL/UL-BWP for the Non-RedCap UE is equal to or less than the maximum bandwidth of the RedCap UE, the RedCap UE can support the conventional initial DL/UL-BWP operation. The CD-SSB (cell defined SSB) in FIG. 2 is an SSB that the RedCap UE receives for obtaining SIB resources.

The RedCap UE supports a random access procedure using a separate initial DL/UL-BWP in order to be able to operate even in a case where the DL/UL-BWP for the Non-RedCap UE exceeds the maximum bandwidth of the RedCap UE.

In the random access procedure, the separate initial UL(/DL)-BWP is configured for the RedCap UE via SIB. The SIB may or may not include CD-SSB.

In the CONNECTED mode, the RedCap UE receives NCD-SSB (Non-cell defined SSB) from the network, and the initial DL/UL-BWP for the RedCap UE is configured based on the received NCD-SSB. The NCD-SSB is an SSB transmitted by using a resource that is different from that of the CD-SSB (cell defining SSB) associated with reception of SIB1. The NCD-SSB is an example of system information.

In the IDLE/INACTIVE mode, an initial DL BWP that is shared with the Non-RedCap UE is configured based on the paging or SIB reception.

As described above, the NCD-SSB is transmitted from the network. The NCD-SSB transmission is an overhead (for example, the load such as added required resources or increased energy consumption) for the network. Therefore, an operation of always transmitting NCD-SSB or the increased number of NCD-SSB transmissions can increase the load for the network. Furthermore, in RedCap (IoT) use cases, the traffic that occurs in the RRC IDLE/INACTIVE state is expected to be dominant among the traffic that occurs in various states of the terminal. In consideration of the above-described points, in the conventional NR standards, the NCD-SSB transmission is specified to be performed by limiting the case to a case in which the RedCap UE is in the RRC_CONNECTED state.

On the other hand, in the NR standardization effort, there is an agreement of using NCD-SSB for SDT (Small Data Transmission) in the separate initial BWP configured for the RedCap UE. Here, the SDT is a function in which the UE performs uplink communications in the RRC_INACTIVE state by using Msg3 PUSCH (RA-SDT) or CG-PUSCH (CG-SDT).

Conventionally, transmission of NCD-SSB is not expected to be performed when the UE is in the RRC_INACTIVE state. Therefore, in the SDT procedure by the RedCap UE that is in the RRC_INACTIVE state, how NCD-SSB is to be received by the RedCap UE is unclear, and there is a risk that the RedCap UE cannot receive NCD-SSB appropriately.

### Embodiment Overview

According to an embodiment of the present invention, the RedCap UE that is in the RRC_INACTIVE state can expect to receive NCD-SSB and the RedCap UE can receive NCD-SSB appropriately. According to an embodiment of the present invention, a terminal 20 that performs an SDT procedure using the separate initial BWP for the RedCap UE expects to receive NCD-SSB: during a period of the SDT procedure; and/or before or after the SDT procedure. The terminal 20 in an embodiment of the present invention is, for example, a RedCap UE.

In this embodiment, the SDT procedure may be referred to as SDT. The SDT is a procedure that enables transmission of data and/or signaling while remaining in the RRC_INACTIVE state (that is, without transitioning to the RRC_CONNECTED state). The SDT can be enabled on a radio bearer basis. The terminal 20 may start the SDT procedure only in a case where: the amount of UL data that awaits transmission in all of the radio bearers for which SDT is enabled is less than the configured amount; DL RSRP exceeds the configured threshold value; and there are valid SDT resources. The maximum period in which the SDT procedure can be continued may be determined based on, for example, a timer that is configured by the network (for example, an SDT failure detection timer). The SDT procedure may be initiated with either a transmission of RACH configured via system information or a transmission of Type 1 CG (configured grant) resources configured via signaling in RRC Release. The SDT resources can be configured on initial BWP for both RACH and CG. In an embodiment of the present invention, the SDT procedure is an example of a procedure for performing uplink transmission in the RRC inactive state.

According to an embodiment of the present invention, the SDT for the terminal 20 for expecting the NCD-SSB transmission may be at least one of the RA-SDT (random access based SDT) or CG-SDT (configured grant SDT). According to an embodiment of the present invention, the terminal 20 may expect to receive NCD-SSB at least N symbols before SDT PUSCH transmission and/or SDT PDSCH reception.

### First Embodiment

In the first embodiment, the terminal 20 may expect that the NCD-SSB is to be received during the RA-SDT (random access based SDT) procedure.

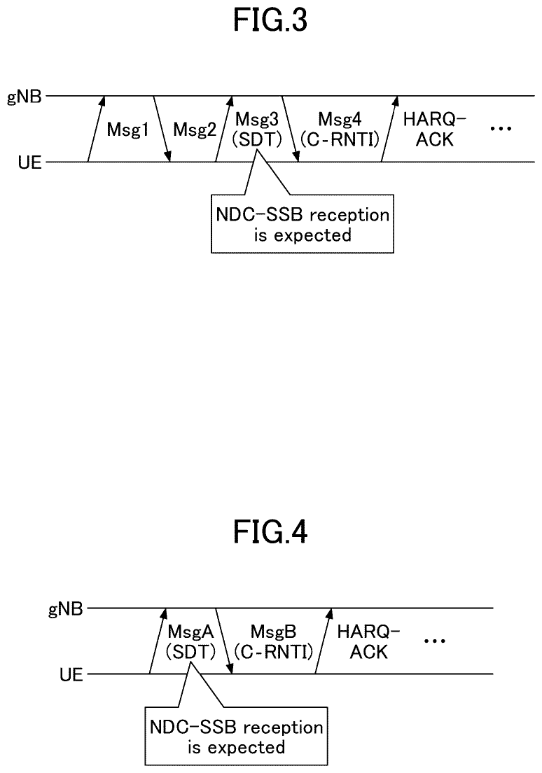

FIG. 3 is a drawing illustrating an example of an RA-SDT procedure with 4-step RACH in the first embodiment. As illustrated in FIG. 3, the NCD-SSB reception may be expected based on the SDT PUSCH transmission via Msg3 from the terminal 20 (UE) in the RA-SDT procedure with 4-step RACH.

FIG. 4 is a drawing illustrating an example of an RA-SDT procedure with 2-step RACH in the first embodiment. As illustrated in FIG. 4, the NCD-SSB reception may be expected based on the SDT PUSCH transmission via MsgA from the terminal 20 (UE) in the RA-SDT procedure with 2-step RACH.

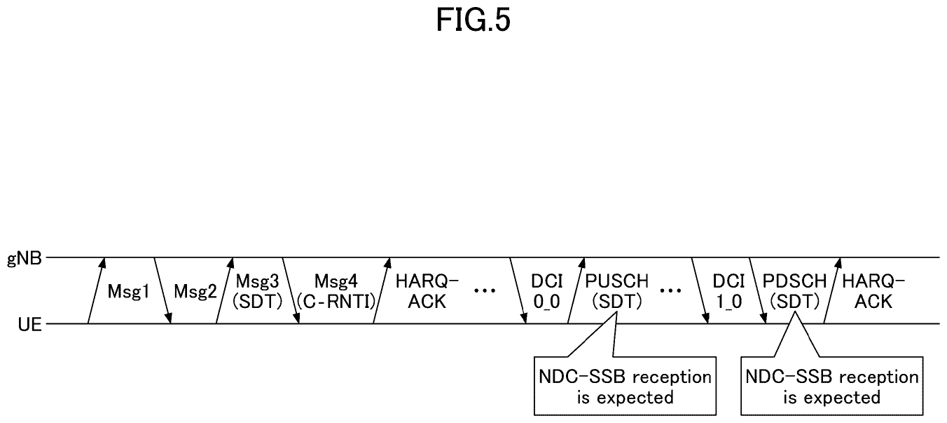

FIG. 5 is a drawing illustrating an example of an RA-SDT procedure with 4-step RACH in the first embodiment. As illustrated in FIG. 5, the NCD-SSB reception may be expected based on at least one of SDT PUSCH transmission or SDT PDSCH reception by the terminal 20 (UE) in the SDT procedure after the contention resolution. The SDT procedure after the contention resolution is also referred to as the subsequent SDT. The terminal 20 monitors PDCCH (DCI format 0_0/1_0) with CRC scrambled by C-RNTI for scheduling PUSCH/PDSCH, and transmits HARQ-ACK for subsequent SDT on the common PUCCH resource as Msg4/MsgB. The SDT procedure after the contention resolution is started after the HARQ-ACK for Msg4/MsgB. It is to be noted that an operation illustrated in FIG. 5 may be applied to the SDT procedure after the contention resolution in the RA-SDT procedure with 2-step RACH.

In examples illustrated in FIGS. 3 to 5, the PRACH transmission occasions (PRACH occasions) may or may not be specific to the SDT.

In the first embodiment, the NCD-SSB reception may be expected based on at least one of SDT PUSCH transmission via Msg3 illustrated in FIG. 3, SDT PUSCH transmission via MsgA illustrated in FIG. 4, or SDT PUSCH transmission and/or SDT PDSCH reception illustrated in FIG. 5.

In the first embodiment, the period during which the terminal 20 expects to receive NCD-SSB may be a period that starts from the first NCD-SSB reception by the terminal 20. The first NCD-SSB reception may be an NCD-SSB immediately before the first SDT PDSCH reception and/or the first SDT PUSCH transmission. The first NCD-SSB reception may be an NCD-SSB immediately before the initial transmission of RA-SDT. The first NCD-SSB reception may be an NCD-SSB immediately before the first transmission or reception of the subsequent SDT PDSCH/PUSCH after the initial transmission of RA-SDT PUSCH.

In the first embodiment, the period during which the terminal 20 expects to receive NCD-SSB may be a period until: completion of SDT PUSCH transmission in Subsequent SDT; completion of SDT PDSCH reception in Subsequent SDT; completion of HARQ-ACK transmission for the SDT PDSCH; or expiration of a timer, the timer being used for configuring the SDT continuation period.

The terminal 20 may expect that the NCD-SSB is periodically transmitted during a period from the first NCD-SSB reception until: SDT PDSCH reception; completion of PUSCH transmission and reception; or expiration of a timer that configures the SDT continuation period.

The terminal 20 may expect that the NCD-SSB is periodically transmitted from the first NCD-SSB reception with an interval of X symbols. The unit of the value X is not limited to symbol, and may be slot or ms.

The value of X may be configured by at least one of SIB, RRC, MAC CE, or DCI. As a different example, the value of X may be specified by the technical specification.

As a modified embodiment of the first embodiment, the terminal 20 may expect that the last symbol of the NCD-SSB is to be received no later than the end of the N-th symbol before the SDT PUSCH transmission via Msq3 illustrated in FIG. 3. The unit of the value N is not limited to symbol, and may be slot or ms.

As a modified embodiment of the first embodiment, the terminal 20 may expect that the last symbol of the NCD-SSB is to be received no later than the end of the N-th symbol before the SDT PUSCH transmission via MsgA illustrated in FIG. 4.

As a modified embodiment of the first embodiment, the terminal 20 may expect that the last symbol of the NCD-SSB is to be received no later than the end of the N-th symbol before SDT PUSCH transmission and/or SDT PDSCH reception in Subsequent SDT illustrated in FIG. 5.

As a modified embodiment of the first embodiment, the terminal 20 may expect that the last symbol of the NCD-SSB is to be received at the N-th symbol before the first symbol of the Subsequent SDT scheduling PDCCH MO (Type-1 CSS and/or CSS configured by sdt-SearchSpace).

As a modified embodiment of the first embodiment, the terminal 20 may expect that the last symbol of the NCD-SSB is to be received at the N-th symbol before the first symbol of Msg3/MsgA/SDT PUSCH in Subsequent SDT.

As a modified embodiment of the first embodiment, the terminal 20 may expect that the last symbol of the NCD-SSB is to be received at the N-th symbol before the first symbol of SDT PDSCH in Subsequent SDT.

### Second Embodiment

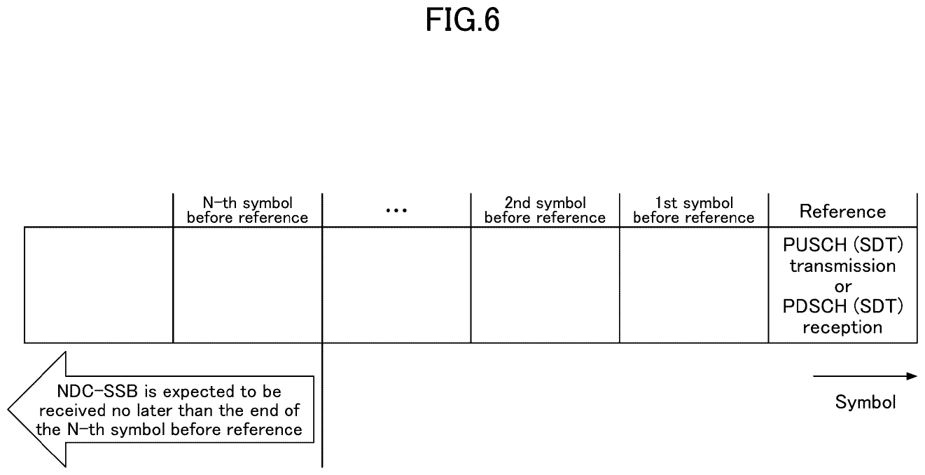

In the second embodiment, as illustrated in FIG. 6, the terminal 20 may expect that the NCD-SSB is to be received no later than the end of the N-th symbol before SDT PUSCH transmission and/or SDT PDSCH reception. The unit of the value N is not limited to symbol, and may be slot or ms.

The gap between the first or last symbol of NCD-SSB and the first or last symbol of SDT PUSCH/PDSCH may be equal to or less than N symbols or may be less than N symbols.

The value of N may vary depending on the SCS (SubCarrier Spacing). As a different example, the value of N may be the same value across a plurality of SCSs.

The value of N may be specified by the technical specification. As a different example, the value of N may be indicated to the terminal 20 via at least one of RRC, SIB, MAC CE, or DCI.

The value of N may be different depending on the capability of the terminal 20 (UE capability).

The value of N may be two symbols for 15/30/60/120 KHz SCS.

The start position of a period in which the terminal 20 expects to receive NCD-SSB in the second embodiment may be the same as the start position of a period in which NCD-SSB is expected to be received in the above-described first embodiment.

### Third Embodiment

In the third embodiment, the terminal 20 may expect that the NCD-SSB is to be received: during the CG-SDT (configured grant SDT) procedure; or before or after the CG-SDT procedure.

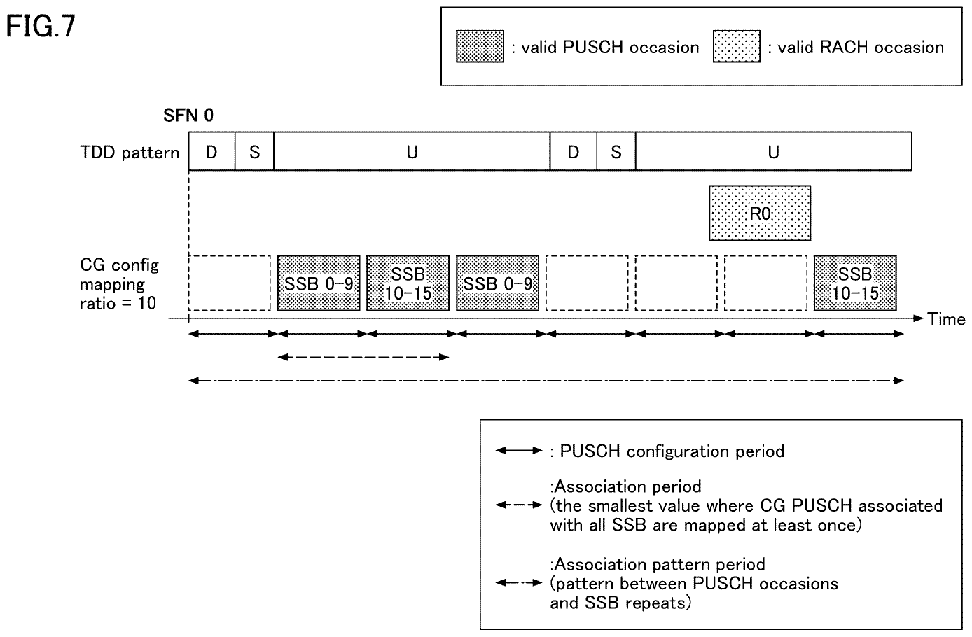

In the third embodiment, the terminal 20 may expect that the NCD-SSB is to be received during the CG-SDT procedure in valid PUSCH occasions illustrated in FIG. 7.

In the third embodiment, the terminal 20 may expect that the NCD-SSB is to be received based on PUSCH transmission and/or PDSCH reception of the subsequent SDT (SDT after the CG-SDT in valid PUSCH occasions) illustrated in FIG. 7.

The terminal 20 may expect that the last symbol of the NCD-SSB is to be received no later than the end of the N-th symbol before the valid PUSCH occasion/Subsequent SDT of CG-SDT. The unit of the value N is not limited to symbol, and may be slot or ms.

The SSB index associated with the valid PUSCH occasion may be an index of NCD-SSB transmitted in the separate initial BWP.

The terminal 20 may expect that the last symbol of the NCD-SSB is to be received at the N-th symbol before the first symbol of the Subsequent SDT scheduling PDCCH MO (Type-1 CSS; and/or CSS and/or USS configured by sdt-SearchSpace).

The terminal 20 may expect that the last symbol of the NCD-SSB is to be received at the N-th symbol/slot/ms before the valid PUSCH occasion/Subsequent SDT PUSCH of CG-SDT.

The terminal 20 may expect that the last symbol of the NCD-SSB is to be received at the N-th symbol before the first symbol of Subsequent SDT PDSCH.

In the third embodiment, the period during which the terminal 20 expects to receive NCD-SSB may be a period that starts from the first NCD-SSB reception by the terminal 20. The first NCD-SSB reception may be an NCD-SSB immediately before the first SDT PDSCH reception and/or the first SDT PUSCH transmission. The first NCD-SSB reception may be an NCD-SSB immediately before the initial transmission of CG-SDT. The first NCD-SSB reception may be an NCD-SSB immediately before the first transmission or reception of the subsequent SDT PDSCH/PUSCH after the initial transmission of CG-SDT PUSCH.

In the third embodiment, the period during which the terminal 20 expects to receive NCD-SSB may be a period until: completion of CG-SDT initial transmission in the valid PUSCH occasion; completion of Subsequent SDT PUSCH transmission; completion of Subsequent SDT PDSCH reception; completion of HARQ-ACK transmission corresponding to SDT PDSCH; or expiration of a timer, the timer being used for configuring the SDT continuation period.

The period during which NCD-SSB is expected to be received may be associated with at least one of PUSCH configuration period, association period, or association pattern period of CG-PUSCH. For example, the terminal 20 may expect that NCD-SSB is to be received at least once in the association pattern period.

The terminal 20 may expect that the NCD-SSB is to be periodically transmitted during a period from the first NCD-SSB reception until: SDT PDSCH reception; completion of PUSCH transmission and reception; or expiration of a timer, the timer being used for configuring the SDT continuation period.

The terminal 20 may expect that the NCD-SSB is to be periodically transmitted from the first NCD-SSB reception with an interval of X symbols. The unit of the value X is not limited to symbol, and may be slot or ms. The value of X may be configured by at least one of SIB, RRC, MAC CE, or DCI. As a different example, the value of X may be specified by the technical specification.

### Other Embodiments

The embodiments described below may be applied to the above-described first to third embodiments.

The NCD-SSB transmitted for SDT and the NCD-SSB transmitted for the RedCap UE in the RRC CONNECTED state may include at least one of the absolute frequency, periodicity, or time offset between CD-SSB and NCD-SSB. The configuration (for example, configuration value) for at least one of the absolute frequency, periodicity, or time offset between CD-SSB and NCD-SSB may be different between the NCD-SSB transmitted for SDT and the NCD-SSB transmitted for the RedCap UE in the RRC CONNECTED state. As a different example, the configuration (for example, configuration value) for the absolute frequency, periodicity, and time offset between CD-SSB and NCD-SSB may be the same between the NCD-SSB transmitted for the SDT operation and the NCD-SSB transmitted for the RedCap UE in the RRC CONNECTED state.

The terminal that expects to receive NCD-SSB for SDT may be determined based on the capability of the terminal (UE capability).

For example, the terminal that supports FG28-1 and does not support FG28-1a may expect to receive NCD-SSB for SDT. The FG28-1 is one of the basic features of the RedCap UE. The FG28-1a indicates an operation in a BWP that does not include an SSB.

For example, the terminal that supports FG28-1 and FG28-1a may expect to receive NCD-SSB for SDT.

For example, a new UE capability may be specified and only the terminal that has reported to support the new UE capability may expect to receive NCD-SSB for SDT.

The RedCap UE in an embodiment of the present invention may be a Rel-17 RedCap UE, a Rel-18 eRedCap UE, or a RedCap UE that supports functions of Rel-18 or later.

The definition of the RedCap UE may be any one of the following 1) to 3), or may be a different definition.
1) The RedCap UE may be defined as a UE that has indicated to the network that the UE itself is a RedCap UE/eRedCap UE by using Msg.1/3/A. For example, the Msg. 1/A may be transmitted using a resource that is specified or configured for the RedCap UE, or an indication field in Msq3 that is specified or configured for the RedCap UE may be used for indicating that the UE itself is a RedCap UE.
2) The RedCap UE may be defined as a UE that supports a specific UE capability. For example, the specific UE capability may be a UE capability of supporting up to 20 MHz bandwidth in FR1 or supporting up to 100 MHz bandwidth in FR2. The specific UE capability may be a UE capability of supporting one or two reception branches and may be a UE capability of supporting the maximum number of DL MIMO layers corresponding to the supported number of reception branches. In addition, the specific UE capability may be a UE capability of supporting an operation of FD-FDD (Full Duplex-Frequency Division Duplex) or an operation of Type A HD-FDD (Half Duplex-Frequency Division Duplex) in the FR1 FDD bands. The specific UE capability may be a UE capability of supporting one of DL up to 64QAM (Quadrature amplitude modulation) or DL up to 256QAM in FR1. The specific UE capability may be a UE capability of not supporting Carrier Aggregation and/or Dual Connectivity. The specific UE capability may be a UE capability of supporting FG28-1 and FG28-1a. The specific UE capability may be a UE capability of supporting up to 5 MHZ bandwidth for PDSCH and PUSCH in FR1. The specific UE capability may be a UE capability of supporting the reduced UE peak data rate in FR1.
3) The RedCap VE may be defined as a UE that has reported, to the network, to support the specific UE capability described in the above-described 2).

The definition of the Non-RedCap UE may be a UE that does not correspond to either the definition of the RedCap UE nor to the definition of the eRedCap UE, may be a UE that supports a function that is supported as a mandatory function by a normal UE, or may be a UE that supports a bandwidth exceeding the maximum bandwidth supported by the RedCap UE.

According to an embodiment of the present invention, the terminal 20 that performs the SDT procedure can expect to receive NCD-SSB and can receive the NCD-SSB appropriately.

### Device Configuration

Next, a functional configuration example of the base station 10 and the terminal 20 for performing the processes and operations described above will be described.

### Base Station

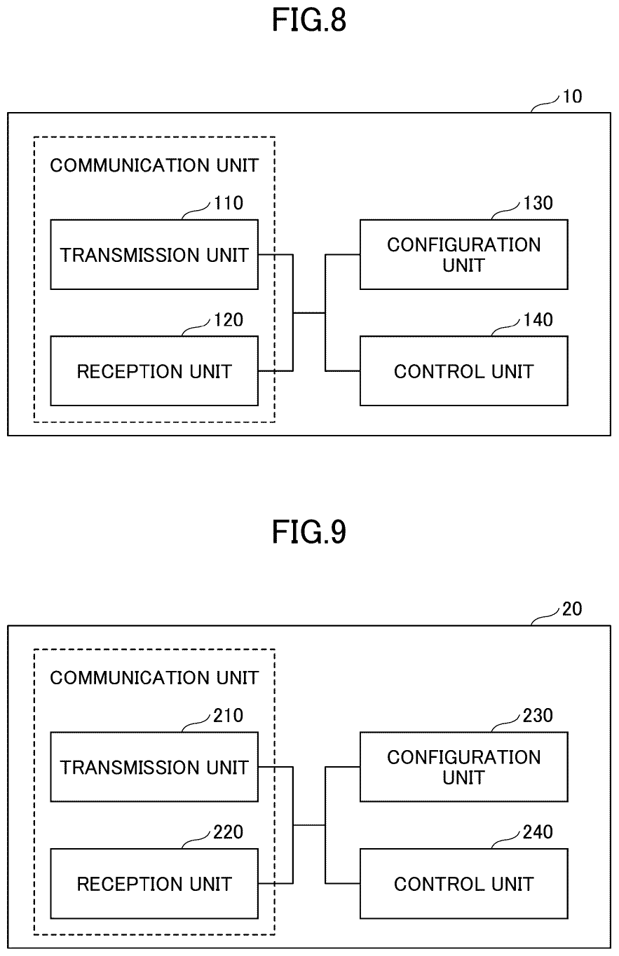

FIG. 8 is a drawing illustrating an example of a functional configuration of a base station 10. As illustrated in FIG. 8, the base station 10 includes a transmission unit 110, a reception unit 120, a configuration unit 130, and a control unit 140. The functional configuration illustrated in FIG. 8 is merely an example. Functional divisions and names of functional units may be anything as long as operations according to an embodiment of the present invention can be performed. Further, the transmission unit 110 and the reception unit 120 may be combined and may be referred to as a communication unit.

The transmission unit 110 includes a function for generating a signal to be transmitted to the terminal 20 side and transmitting the signal wirelessly. The reception unit 120 includes a function for receiving various signals transmitted from the terminal 20 and acquiring, for example, information of a higher layer from the received signals. Further, the transmission unit 110 has a function of transmitting NR-PSS, NR-SSS, NR-PBCH, DL/UL control signals, DCI via PDCCH, data via PDSCH, and the like, to the terminal 20.

The configuration unit 130 stores preset configuration information and various configuration information items to be transmitted to the terminal 20 in a storage device included in the setting unit 130 and reads the preset configuration information from the storage apparatus if necessary.

The control unit 140 performs scheduling of the terminal 20 for DL reception or UL transmission, via the transmission unit 110. In addition, the control unit 140 includes a function of performing LBT. The functional units related to signal transmission in the control unit 140 may be included in the transmission unit 110, and the functional units related to signal reception in the control unit 140 may be included in the reception unit 120. Further, the transmission unit 110 may be referred to as a transmitter, and the reception unit 120 may be referred to as a receiver.

### Terminal

FIG. 9 is a drawing illustrating an example of a functional configuration of a terminal 20. As illustrated in FIG. 9, the terminal 20 includes a transmission unit 210, a reception unit 220, a configuration unit 230, and a control unit 240. The functional configuration illustrated in FIG. 9 is merely an example. Functional divisions and names of functional units may be anything as long as operations according to an embodiment of the present invention can be performed. the transmission unit 210 and the reception unit 220 may be combined and may be referred to as a communication unit.

The transmission unit 210 generates a transmission signal from transmission data and transmits the transmission signal wirelessly. The reception unit 220 receives various signals wirelessly and obtains higher layer signals from the received physical layer signals. In addition, the reception unit 220 has a function of receiving NR-PSS, NR-SSS, NR-PBCH, DL/UL/SL control signals, DCI via PDCCH, data via PDSCH, etc., transmitted from the base station 10. In addition, for example, with respect to the D2D communications, the transmission unit 210 may transmit, to another terminal 20, PSCCH (Physical Sidelink Control Channel), PSSCH (Physical Sidelink Shared Channel), PSDCH (Physical Sidelink Discovery Channel), PSBCH (Physical Sidelink Broadcast Channel), etc., and the reception unit 120 may receive, from the another terminal 20, PSCCH, PSSCH, PSDCH, PSBCH, etc.

The configuration unit 230 stores various configuration information items received from the base station 10 or the another terminal by the reception unit 220 in the storage device included in the configuration unit 230, and reads them from the storage device as necessary. In addition, the configuration unit 230 also stores pre-configured configuration information. The control unit 240 controls the terminal 20. In addition, the control unit 240 includes a function of performing LBT.

### Hardware Structure

The block diagrams that have been used for describing the above-described embodiments (FIG. 8 and FIG. 9) indicate blocks in functional units. These functional blocks (components) may be implemented in arbitrary combinations of at least one of hardware or software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, the functional block (component) to implement a function of transmission may be referred to as a transmitting unit or a transmitter. The method for implementing each component is not particularly limited as described above.

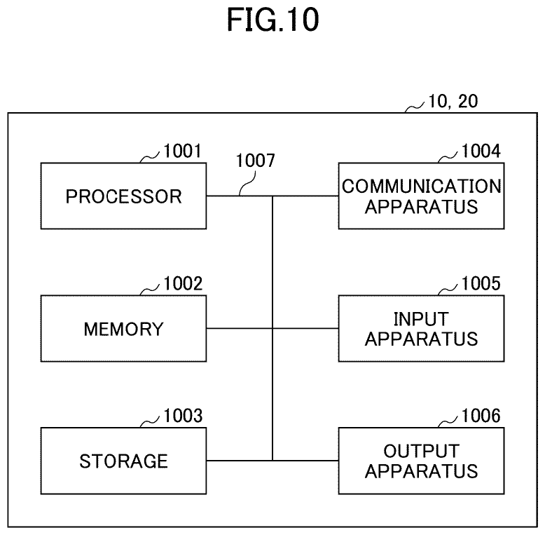

For example, the base station 10, the terminal 20, etc., according to an embodiment of the present disclosure may function as a computer for processing the radio communication method of the present disclosure. FIG. 10 is a drawing illustrating an example of a hardware structure of a base station 10 and a terminal 20 according to an embodiment of the present disclosure. Physically, the above-described base station 10 and terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the following description, the word “apparatus” can be interpreted as a circuit, a device, a section, a unit, and so on. The hardware structure of the base station 10 and the terminal 20 may be configured to include one or more of apparatuses shown in the drawings, or may be configured not to include part of apparatuses.

Each function of the base station 10 and the terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading or writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, the above-described control unit 140, control unit 240, and so on may be implemented by the processor 1001.

Furthermore, the processor 1001 reads programs (program codes), software modules, data, or the like, from at least one of the storage 1003 and the communication apparatus 1004, into the memory 1002, and executes various processes according to these. As for the programs, programs to allow computers to execute at least part of the operations of the above-described embodiments are used. For example, the control unit 140 of the base station 8 illustrated in FIG. 10 may be implemented by control programs that are stored in the memory 1002 and that operate on the processor 1001. In addition, for example, the control unit 240 of the terminal 20 illustrated in FIG. 9 may be implemented by control programs that are stored in the memory 1002 and that operate on the processor 1001. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may be constituted with, for example, at least one of a Read Only Memory (ROM), an Erasable Programmable ROM (EPROM), an Electrically Erasable Programmable ROM (EEPROM), a Random Access Memory (RAM), or other appropriate storage media. The memory 1002 may be referred to as a “register,” a “cache,” a “main memory (primary storage apparatus)” and so on. The memory 1002 can store executable programs (program codes), software modules, and the like for implementing the communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, or other appropriate storage media. The above recording medium may be a database including the memory 1002 and/or the storage 1003, a server, or any other appropriate medium.

The communication apparatus 1004 is hardware (transmitting/receiving device) for allowing inter-computer communication via at least one of wired or wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) or time division duplex (TDD). For example, the transmitting/receiving antenna, the amplifier unit, the transmitting/receiving unit, the transmission line interface, and the like, may be implemented by the communication apparatus 1004. The transmitting/receiving unit may be physically or logically divided into a transmitting unit and a receiving unit.

The input apparatus 1005 is an input device that receives input from the outside (for example, a keyboard, a mouse, a microphone, a switch, a button, a sensor, and so on). The output apparatus 1006 is an output device that outputs something to the outside (e.g., display, speaker, LED lamp). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

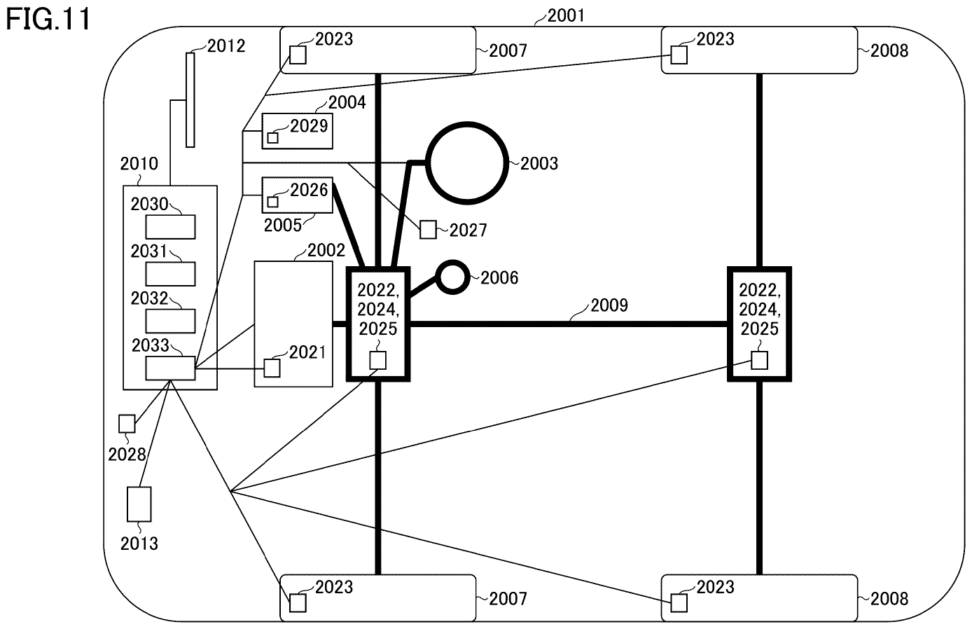

FIG. 11 illustrates an example of a configuration of a vehicle 2001. As shown in FIG. 11, the vehicle 2001 includes a drive unit 2002, a steering unit 2003, an accelerator pedal 2004, a brake pedal 2005, a shift lever 2006, a front wheel 2007, a rear wheel 2008, an axle 2009, an electronic control unit 2010, various sensors 2021-2029, an information service unit 2012, and a communication module 2013. The aspects/embodiments described in the present disclosure may be applied to a communication device mounted in the vehicle 2001, and may be applied to, for example, the communication module 2013.

The drive unit 2002 may include, for example, an engine, a motor, and a hybrid of an engine and a motor. The steering unit 2003 includes at least a steering wheel and is configured to steer at least one of the front wheel or the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the various sensors 2021-2029 provided in the vehicle 2001. The electronic control unit 2010 may be referred to as an ECU (Electronic control unit).

The signals from the various sensors 2021 to 2029 include a current signal from a current sensor 2021 which senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, a stepped-on accelerator pedal signal acquired by an accelerator pedal sensor 2029, a stepped-on brake pedal signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing (outputting) various kinds of information such as driving information, traffic information, and entertainment information, including a car navigation system, an audio system, a speaker, a television, and a radio, and one or more ECUS controlling these devices. The information service unit 2012 provides various types of multimedia information and multimedia services to the occupants of the vehicle 2001 by using information obtained from the external device through the communication module 2013 or the like.

The information service unit 2012 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving support system unit 2030 includes: various devices for providing functions of preventing accidents and reducing driver's operating loads such as a millimeter wave radar, a LiDAR (Light Detection and Ranging), a camera, a positioning locator (e.g., GNSS, etc.) , map information (e.g., high definition (HD) map, autonomous vehicle (AV) map, etc. ), a gyro system (e.g., IMU (Inertial Measurement Unit) , INS (Inertial Navigation System), etc. ), an AI (Artificial Intelligence) chip, an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 2001 via a communication port. For example, the communication module 2013 transmits and receives data via a communication port 2033, to and from a drive unit 2002, a steering unit 2003, an accelerator pedal 2004, a brake pedal 2005, a shift lever 2006, front wheels 2007, rear wheels 2008, an axle 2009, a microprocessor 2031 and a memory (ROM, RAM) 2032 in the electronic control unit 2010, and sensors 2021 to 2029 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, a base station, a mobile station, or the like.

The communication module 2013 may transmit at least one of signals from the various sensors 2021 to 2029 described above input to the electronic control unit 2010, information obtained based on the signals, and information based on an input from the outside (a user) obtained via the information service unit 2012, to the external apparatus via radio communication. The electronic control unit 2010, the various sensors 2021 to 2029, the information service unit 2012, and the like may be referred to as input units that receive input. For example, the PUSCH transmitted by the communication module 2013 may include information based on the input.

The communication module 2013 receives various types of information (traffic information, signal information, inter-vehicle information, etc.) transmitted from the external devices and displays the received information on the information service unit 2012 provided in the vehicle 2001. The information service unit 2012 may be referred to as an output unit that outputs information (for example, outputs information to devices, such as a display, a speaker, or the like, based on the PDSCH received by the communication module 2013 (or data/information decoded from the PDSCH)).

In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the front wheel 2007, the rear wheel 2008, the axle 2009, the sensors 2021-2029, etc., mounted in the vehicle 2001.

A terminal according to an embodiment of the present invention may be configured as a terminal described in each item below. In addition, a communication method described below may be performed.

### Configuration Related to an Embodiment of the Present Invention

### First Item

A terminal including:
a transmission unit configured to perform an uplink transmission in an RRC (Radio Resource Control) inactive state;
a control unit configured to expect to receive system information, at least one of: during execution of a data transmission procedure for performing the uplink transmission; before execution of the data transmission procedure; or after execution of the data transmission procedure; and
a reception unit configured to receive the system information based on the expectation.

### Second Item

In the terminal as described in the first item,
the data transmission procedure is a data transmission procedure based on a random access procedure, and
the control unit expects to receive the system information, based on a message transmission in the random access procedure.

### Third Item

In the terminal as described in the first item,
the data transmission procedure is a data transmission procedure after a contention resolution, and
the control unit expects to receive the system information, based on transmission of an uplink shared channel or reception of a downlink shared channel, after the contention resolution.

### Fourth Item

In the terminal as described in the first item,
the control unit expects to receive the system information, based on a transmission occasion of a valid uplink shared channel.

### Fifth Item

A communication method performed by a terminal, the communication method including:
performing an uplink transmission in an RRC inactive state;
expecting to receive system information, at least one of: during execution of a data transmission procedure for performing the uplink transmission; before execution of the data transmission procedure; or after execution of the data transmission procedure; and
receiving the system information based on the expectation.

### Sixth Item

A wireless communication system including: a terminal; and a base station, wherein
the base station transmits system information, and
the terminal
performs an uplink transmission, to the base station, in an RRC inactive state;
expects to receive system information, at least one of: during execution of a data transmission procedure for performing the uplink transmission; before execution of the data transmission procedure; after execution of the data transmission procedure; and
receives the system information based on the expectation.

According to any one of the above-described configurations, the system information can be expected to be received even if the capability reduced terminal is in an RRC inactive state in the wireless communication system. According to the first item, the fifth item, and the sixth item, the system information can be expected to be received, at least one of: during execution of a data transmission procedure for performing the uplink transmission; before execution of the data transmission procedure; or after execution of the data transmission procedure. According to the second item, the system information can be expected to be received, based on a message transmission in the random access procedure. According to the third item, the system information can be expected to be received, based on transmission of an uplink shared channel or reception of a downlink shared channel, after the contention resolution. According to the fourth item, the system information can be expected to be received, based on a transmission occasion of a valid uplink shared channel.

### Supplement of Embodiment

As described above, one or more embodiments have been described. The present invention is not limited to the above embodiments. A person skilled in the art should understand that there are various modifications, variations, alternatives, replacements, etc., of the embodiments. In order to facilitate understanding of the present invention, specific values have been used in the description. However, unless otherwise specified, those values are merely examples and other appropriate values may be used. The division of the described items may not be essential to the present invention. The things that have been described in two or more items may be used in a combination if necessary, and the thing that has been described in one item may be appropriately applied to another item (as long as there is no contradiction). Boundaries of functional units or processing units in the functional block diagrams do not necessarily correspond to the boundaries of physical parts. Operations of multiple functional units may be physically performed by a single part, or an operation of a single functional unit may be physically performed by multiple parts. The order of sequences and flowcharts described related to an embodiment of the present invention may be changed as long as there is no contradiction. For the sake of description convenience, the base station 10 and the terminal 20 have been described by using functional block diagrams. However, the apparatuses may be realized by hardware, software, or a combination of hardware and software. The software executed by a processor included in the base station 10 according to an embodiment of the present invention and the software executed by a processor included in the terminal 20 according to an embodiment of the present invention may each be stored in a random access memory (RAM), a flash memory, a read only memory (ROM), an EPROM, an EEPROM, a register, a hard disk (HDD), a removable disk, a CD-ROM, a database, a server, any other appropriate recording medium.

In addition, notification of information is by no means limited to the aspects/embodiments described in the present disclosure, and other methods may be used as well. For example, the indication of information may be performed by physical layer signaling (e.g., DCI (Downlink Control Information), UCI (Uplink Control Information)), upper layer signaling (e.g., RRC (Radio Resource Control) signaling, MAC (Medium Access Control) signaling, broadcast information (MIB (Master Information Block), SIB (System Information Block))), other signals, or combinations thereof. Also, RRC signaling may be referred to as an “RRC message,” and can be, for example, an RRC connection setup message, an RRC connection reconfiguration message, and so on.

The aspects/embodiments illustrated in the present disclosure may be applied to at least one of Long Term Evolution (LTE), LTE-Advanced (LTE-A), SUPER 3G, IMT-Advanced, 4th generation mobile communication system (4G), 5th generation mobile communication system (5G), 6th generation mobile communication system (6G), xth generation mobile communication system (xG) (where x is, for example, an integer or a decimal) ), Future Radio Access (FRA), New-Radio (NR), New radio access (NX), Future generation radio access (FX), W-CDMA (registered trademark), GSM (registered trademark), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods, next-generation systems that are enhanced, modified, created, or defined based on these, or the like. In addition, a plurality of systems may be combined (for example, a combination of: at least one of LTE or LTE-A; and 5G, and the like) to be applied.

The order of processes, sequences, flowcharts, and so on that have been used to describe the aspects/embodiments in the present specification may be re-ordered as long as inconsistencies do not arise. For example, although various methods have been illustrated in the present disclosure with various components of steps in exemplary orders, the specific orders that are illustrated herein are by no means limiting.

Operations which have been described in the present specification to be performed by a base station 10 may, in some cases, be performed by an upper node of the base station 10. In a network including one or a plurality of network nodes with base stations 10, it is clear that various operations that are performed to communicate with terminals 20 can be performed by base stations 10, one or more network nodes (for example, Mobility Management Entities (MMEs), Serving-Gateways (S-GWs), and so on may be possible, but these are not limiting) other than base stations 10, or combinations of these. According to the above, a case is described in which there is a single network node other than the base station 10. However, a combination of multiple other network nodes may be considered (e.g., MME and S-GW).

The information or signals described in this disclosure may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in the present disclosure may be implemented by a value (0 or 1) represented by one bit, by a boolean value (true or false), or by comparison of numerical values (e.g., comparison with a predetermined value).

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) or wireless technologies (infrared, microwave, etc.) , at least one of these wired line technologies or wireless technologies is included within the definition of the transmission medium.

Information, a signal, or the like, described in the present specification may be represented by using any one of various different technologies. For example, data, an instruction, a command, information, a signal, a bit, a symbol, a chip, or the like, described throughout the present application, may be represented by a voltage, an electric current, electromagnetic waves, magnetic fields, a magnetic particle, optical fields, a photon, or a combination thereof.

It should be noted that a term used in the present specification and/or a term required for understanding of the present specification may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because various channels (e.g., PUCCH, PDCCH, or the like) and information elements may be identified by any suitable names, the various names assigned to these various channels and information elements are not used as limitations.

In the present disclosure, the terms such as a “base station (BS),” a “radio base station,” a “fixed station,” a “NodeB,” an “eNB (eNodeB),” a “gNB (gNodeB),” an “access point,” a “transmission point,” a “reception point,” a “transmission/reception point,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station supports a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station or a base station subsystem that provides communication services within this coverage.

In the present disclosure, transmitting information to the terminal by the base station may be referred to as instructing the terminal to perform any control and/or operation based on the information by the base station.

In the present disclosure, the terms such as “Mobile Station (MS)”, “user terminal”, “User Equipment (UE)”, “terminal”, or the like, may be used interchangeably.

A mobile station may be referred to as a “subscriber station,” “mobile unit,” “subscriber unit,” “wireless unit,” “remote unit,” “mobile device,” “wireless device,” “wireless communication device,” “remote device, ” “mobile subscriber station,” “access terminal,” “mobile terminal,” “wireless terminal,” “remote terminal,” “handset,” “user agent,” “mobile client,” “client,” or some other appropriate terms in some cases.

At least one of a base station or a mobile station may be referred to as a “transmitting apparatus,” a “receiving apparatus,” a “radio communication apparatus,” and so on. Note that at least one of a base station or a mobile station may be a device mounted on a moving object or a moving object itself, and so on. The mobile station may be a vehicle (e.g., a car, an airplane, etc.), an unmanned mobile body (e.g., a drone, an automated vehicle, etc.), or a robot (manned or unmanned). Note that at least one of a base station or a mobile station also includes an apparatus which does not necessarily move during communication operation. For example, at least one of the base station or the mobile station may be an IoT (Internet of Things) device such as a sensor.

Furthermore, the base station in the present disclosure may be interpreted as a user terminal. For example, each aspect/embodiment of the present disclosure may be applied to the structure in which communications between a base station and a user terminal is replaced with communications between a plurality of terminals 20 (for example, which may be referred to as Device-to-Device (D2D), Vehicle-to-Everything (V2X), and the like). In this case, terminals 20 may have the functions of the base stations 10 described above. The words such as “uplink” and “downlink” may be interpreted as the words corresponding to the terminal-to-terminal. communication (for example, “sidelink”). For example, an uplink channel, a downlink channel and so on may be interpreted as a sidelink channel.

Likewise, the user terminal in the present disclosure may be interpreted as base station. In this case, the base station may have the functions of the user terminal described above.

As used herein, the term “determining” may encompasses a wide variety of actions. For example, “determining” may be regarded as judging, calculating, computing, processing, deriving, investigating, looking up (search, inquiry) (e. g., looking up in a table, a database or another data structure), ascertaining and the like. Also, “determining” may be regarded as receiving (e. g., receiving information), transmitting (e. g., transmitting information), inputting, outputting, accessing (e. g., accessing data in a memory) and the like. Also, “determining” may be regarded as resolving, selecting, choosing, establishing, comparing, and the like. That is, “determining” may be regarded as a certain type of action related to determining. Further, “decision” may be read as “assuming”, “expecting”, or “considering”, etc.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

A reference signal may be abbreviated as an “RS,” and may be referred to as a “pilot,” and so on, depending on which standard is applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of”and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

“Means” included in the configuration of each of the above apparatuses may be replaced by “parts”, “circuits”, “devices”, etc.

In the case where the terms “include”, “including” and variations thereof are used in the present disclosure, these terms are intended to be comprehensive in the same way as the term “comprising”. Further, the term “or” used in the present specification is not intended to be an “exclusive or”.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may have a fixed time length (for example, 1 ms) that does not depend on the numerology.

Numerology may be a communication parameter applied to at least one of transmission or reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, or the like.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as PDSCH (or PUSCH) mapping type A. A PDSCH (or PUSCH) transmitted using a mini-slot may be referred to as PDSCH (or PUSCH) mapping type B.

A radio frame, a subframe, a slot, a mini-slot, and a symbol all express time units in signal communication. A radio frame, a subframe, a slot, a mini-slot, and a symbol may each be called by other applicable terms.

For example, one subframe may be referred to as a transmission time interval (TTI), a plurality of consecutive subframes may be referred to as a TTI, or one slot or one mini-slot may be referred to as a TTI. In other words, at least one of a subframe or a TTI may be a subframe (1 ms) in the conventional LTE, may be a period shorter than 1 ms (for example, 1 to 13 symbols), or may be a period longer than 1 ms. It is to be noted that the unit representing TTI may be referred to as a slot, a mini-slot, or the like, instead of a subframe.

Here, a TTI refers to the minimum time unit of scheduling in the radio communication, for example. For example, in LTE systems, a base station performs, for each terminal 20, scheduling of allocating radio resources (such as a frequency bandwidth and transmission power that can be used by each terminal 20) in TTI units. It is to be noted that the definition of the TTI is not limited to the above-described definition.

The TTI may be a transmission time unit for channel-encoded data packets (transport blocks), code blocks, codewords, or the like, or may be a unit of processing in scheduling, link adaptation, or the like. It is to be noted that, when a TTI is provided, a time period (for example, the number of symbols) to which transport blocks, code blocks, codewords, or the like are actually mapped may be shorter than the TTI.

It is to be noted that, in a case where one slot or one mini-slot is referred to as a TTI, one or more ITIs (that is, one or more slots or one more mini-slots) may be the minimum time unit of scheduling. Furthermore, the number of slots (the number of mini-slots) constituting the minimum time unit of the scheduling may be controlled.

A TTI having a time length of 1 ms may be referred to as a normal TTI (ITI in LTE Rel. 8 to Rel. 12), a long TTI, a normal subframe, a long subframe, a slot, or the like. A TTI that is shorter than a normal TTI may be referred to as a shortened TTI, a short TTI, a partial or fractional TTI, a shortened subframe, a short subframe, a mini-slot, a sub-slot, a slot and so on.

It is to be noted that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and having a TTI length equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of the numerology, and may be 12, for example. The number of subcarriers included in an RB may be determined based on the numerology.

In addition, an RB may include one or a plurality of symbols in the time domain, and may have a length of one slot, one mini-slot, one subframe, or one TTI. One TTI, one subframe, and the like, may each be constituted of one or a plurality of resource blocks.

Note that one or a plurality of RBs may be referred to as a physical resource block (Physical RB (PRB) ), a sub-carrier group (SCG), a resource element group (REG), a PRB pair, an RB pair and so on.

Furthermore, a resource block may be constituted of one or a plurality of resource elements (REs). For example, one RE may correspond to a radio resource area including one subcarrier and one symbol.

A bandwidth part (BWP) (which may be referred to as a fractional bandwidth, and so on) may represent a subset of contiguous common resource blocks (common RBs) for certain numerology in a certain carrier. Here, a common RB may be identified by an RB index based on the common reference point of the carrier. PRBs may be defined by a certain BWP and may be numbered in the BWP.

A BWP may include a BWP for UL (UL BWP) and a BWP for DL (DL BWP). One or a plurality of BWPs may be configured in one carrier for a terminal 20.

At least one of configured BWPs may be active, and a terminal 20 is not required to expect to transmit/receive a certain signal/channel outside the active BWP. It is to be noted that that a “cell”, a “carrier”, or the like, in the present disclosure may be interpreted as a “BWP”.

The above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be changed in the various manners.

In the present disclosure, in a case where an article is added by translation, for example “a”, “an”, and “the”, the disclosure may include that the noun following these articles is plural.

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different”.

Each aspect/embodiment described in the present specification may be used independently, may be used in combination, or may be used by switching according to operations. Further, notification (transmission/reporting) of predetermined information (e. g., notification (transmission/reporting) of “X”) is not limited to an explicit notification (transmission/reporting), and may be performed by an implicit notification (transmission/reporting) (e.g., by not performing notification (transmission/reporting) of the predetermined information).

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

### DESCRIPTION OF THE REFERENCE NUMERALS

10 Base station
110 Transmission unit
120 Reception unit
130 Configuration unit
140 Control unit
20 Terminal
210 Transmission unit
220 Reception unit
230 Configuration unit
240 Control unit
1001 Processor
1002 Memory
1003 Storage
1004 Communication apparatus
1005 Input apparatus
1006 Output apparatus
2001 Vehicle
2002 Drive unit
2003 Steering unit
2004 Accelerator pedal
2005 Brake pedal
2006 Shift lever
2007 Front wheel
2008 Rear wheel
2009 Axle
2010 Electronic control unit
2012 Information service unit
2013 Communication module
2021 Current sensor
2022 Revolution sensor
2023 Pneumatic sensor
2024 Vehicle speed sensor
2025 Acceleration sensor
2026 Brake pedal sensor
2027 Shift lever sensor
2028 Object detection sensor
2029 Accelerator pedal sensor
2030 Driving support system unit
2031 Microprocessor
2032 Memory (ROM, RAM)
2033 Communication port (IO port)

1. A terminal comprising:
a transmission unit configured to perform an uplink transmission in an RRC (Radio Resource Control) inactive state;
a control unit configured to expect to receive system information, at least one of: during execution of a data transmission procedure for performing the uplink transmission; before execution of the data transmission procedure; or after execution of the data transmission procedure; and
a reception unit configured to receive the system information based on the expectation.

2. The terminal as claimed in claim 1, wherein
the data transmission procedure is a data transmission procedure based on a random access procedure, and
the control unit expects to receive the system information, based on a message transmission in the random access procedure.

3. The terminal as claimed in claim 1, wherein
the data transmission procedure is a data transmission procedure after a contention resolution, and
the control unit expects to receive the system information, based on transmission of an uplink shared channel or reception of a downlink shared channel, after the contention resolution.

4. The terminal as claimed in claim 1, wherein
the control unit expects to receive the system information, based on a transmission occasion of a valid uplink shared channel.

5. A communication method performed by a terminal, the communication method comprising:
performing an uplink transmission in an RRC (Radio Resource Control) inactive state;
expecting to receive system information, at least one of: during execution of a data transmission procedure for performing the uplink transmission; before execution of the data transmission procedure; or after execution of the data transmission procedure; and
receiving the system information based on the expectation.

6. A wireless communication system including: a terminal; and a base station, wherein
the base station transmits system information, and
the terminal
performs an uplink transmission, to the base station, in an RRC (Radio Resource Control) inactive state;
expects to receive system information, at least one of: during execution of a data transmission procedure for performing the uplink transmission; before execution of the data transmission procedure; or ter execution of the data transmission procedure; and
receives the system information based on the expectation.
